(19) United States
(12) Patent Application Publication
(10) Pub. No.: US 2005/0183457 A1
(43) Pub. Date: Aug. 25, 2005

(54) Method of manufacturing optical glass elements

(75) Inventors: Shinichiro Hirota, Fuchu-shi (JP); Hiroyuki Sakai, Nerima-ku (JP); Shigeaki Ohmi, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/053,835

(22) Filed: Feb. 10, 2005

(30) Foreign Application Priority Data
Feb. 10, 2004 (JP) 2004-32952

(51) Int. Cl. C03C 23/00

(52) U.S. Cl. 65/102; 65/111

(57) ABSTRACT

A method of manufacturing optical glass elements by means of mold pressing, wherein a heat-softened glass material is press molded with a pressing mold to manufacture optical glass elements. The refractive index of the optical glass elements is precisely adjusted so that the manufactured optical glass elements exhibit predetermined refractive index.

### FIELD OF THE INVENTION

The present invention relates to a method of manufacturing optical glass elements by means of mold pressing, wherein a heat-softened glass material is press molded with a pressing mold to manufacture optical glass elements. More particularly, the present invention relates to a method of manufacturing optical glass elements of predetermined refractive index in which the refractive index of the optical glass elements is precisely adjusted.

### BACKGROUND OF THE INVENTION

A method of manufacturing optical glass elements such as lenses without requiring a polishing step by press molding a heat-softened glass material with a pressing mold having precisely processed molding surfaces is currently being employed to inexpensively mass produce optical glass elements. This method is called as the glass mold pressing method. In this method, to enhance production efficiency, an attempt is made to accelerate cooling of the glass molded article following press molding in order to reduce the cycle time, the time required to produce one optical glass element. However, the refractive index of the molded glass article changes as a result of the conditions under which the molded glass article is cooled following press molding, sometimes precluding the obtaining of optical glass elements of desired refractive index.

Accordingly, annealing the molded glass article that has been cooled, that is, adjusting the refractive index by heat treatment at a temperature greater than the strain point but lower than the annealing point, is known to yield an optical glass element of desired refractive index. The term “annealing point” normally refers to the point at which the glass viscosity reaches 10¹³ dPas, and the strain point normally refers to the point at which the glass viscosity reaches 10^{14.6} dPas.

By contrast, Japanese Patent No. 3,196,952 (Reference 1) describes a method permitting omission of the annealing step by conducting molding with a glass material having a refractive index value calculated by subtracting the amount of change in refractive index produced by press molding from the value of the refractive index required in the molded optical glass element.

Further, Japanese Unexamined Patent Publication (KOKAI) Heisei No. 10-7423 (Reference 2) describes a method in which an optical element material is softened, by heating to a temperature at which it will deform, and pressed with a pair of molds to transfer the surface shape of the molds to the optical element material, after which the optical element is thermally deformed and separated from the mold. It is disclosed that in this method, annealing is conducted to eliminate refractive index distribution and internal strain in the optical element following separation from the mold. In the annealing process, the molded optical element is heated to the annealing point and maintained there for a certain time. Subsequently, it is gradually cooled to the strain point. It is stated that strain is thus removed and refractive index distribution eliminated from the optical element.

The inexpensive manufacturing of optical elements such as glass lenses of good optical performance by glass mold pressing, as set forth above, requires both the use of a mold that has been precision processed to the shape of the optical element to be obtained, and the acceleration of the heating and cooling steps required in the pressing step to shorten the production cycle time and achieve continuous production. However, when manufacturing optical elements at such a short cycle time, the following problems accompany rapid cooling.

The refractive index (nd, for example) of the glass employed as the molding material changes based on the thermal history accrued in the steps from when the glass is at a temperature rendering it a viscous fluid to when it becomes a solidified optical element. Accordingly, it is necessary to strictly manage the cooling step following pressing in order to stably and continuously obtain optical elements of desired refractive index. However, there are cases where the refractive index drops below the desired range when the cooling rate is increased to shorten the cycle time, and cases where the cooling rate cannot be reproduced with good control. As a result, the refractive index of the optical element obtained does not always fall within the prescribed range.

Reference 1 above is described as being a method not requiring regulation of the refractive index by annealing. To obviate the need for annealing, a glass material having a refractive index calculated to take into account the amount of change in refractive index caused by cooling is prepared and employed. However, when the cooling rate following pressing is changed to shorten the cycle time, the refractive index of the lens obtained changes. Thus, it becomes necessary to reformulate the composition of the glass material to obtain glass of the desired refractive index so as to obtain a lens of desired refractive index following a change in the cooling rate; this is quite burdensome.

In the method described in Reference 2 above, strain and refractive index distribution produced by reheating are eliminated by annealing at a temperature between the annealing point and the strain point. However, when cooling is rapidly conducted following the molding step to shorten the cycle time, substantial stress remains within the optical element. When such the optical element is subjected to the above-mentioned annealing, the stress is reduced. As a result, surface precision deteriorates undesirably so that an astigma (curvature deviation from the rotational symmetry of a lens) and irregularities (rotationally symmetric curvature deviation occurring in a lens) occur anew. That is, when the optical element that has been rapidly cooled following molding is subjected to the annealing that has conventionally been conducted at a temperature between the annealing point and the strain point, surface precision deteriorates, precluding the obtaining of the desired optical glass element.

The present invention has for its object to solve the above problems of a glass mold pressing method. That is, the present invention has for its object to provide a method of manufacturing optical glass elements in which an optical glass element having surface precision and a refractive index falling within predetermined ranges with good precision can be efficiently manufactured.

### BRIEF SUMMARY OF THE INVENTION

The present invention, which solves the above-stated problems, is a method of manufacturing an optical glass element comprising:
press-molding a heat-softened glass material in a pressing mold,
cooling a glass article obtained by said press-molding along with the pressing mold to a temperature less than or equal to the glass transition temperature of the glass article,
removing the glass article from the pressing mold, and
subjecting the glass article to a heat-treatment at a temperature within a range of less than the strain point temperature and equal to or greater than the strain point temperature minus 150° C.

In the present invention, the followings are examples of preferred embodiments:
1. the cooling is conducted so that the refractive index of the molded glass article deviate from the range of refractive index, which range being predetermined for the optical glass element;
2. the average cooling rate within a range of from 100 to 300° C./min is employed until reaching the glass transition temperature during the cooling;
3. the heat treatment is conducted so that the refractive index of the molded glass article shifts to an extent sufficient to fall within the predetermined refractive index range of the optical glass element;
4. the temperature of the heat treatment is determined based on the refractive index of the molded glass article and the predetermined refractive index of the optical glass element.
5. the press molding comprises: supplying the glass material to the pressing mold, said glass material being heated up to a temperature higher than the temperature of the pressing mold and being of glass viscosity of from 10⁶ to 10⁸ poises, said pressing mold being heated to a temperature corresponding to a viscosity of the glass material of from 10⁷ to 10¹⁰ poises; and press molding the glass material immediately after the supplying.

### BRIEF DESCRIPTION OF THE DRAWINGS

FIG. 1 is a schematic of the pressing mold employed in the embodiment.

FIG. 2 gives the results of evaluation of the curvature and refractive index of optical glass elements.

FIG. 3 gives the results of evaluation of the curvature and refractive index of optical glass elements.

FIG. 4 shows the relation between the difference in refractive index (,, nd) of the optical glass element from the predetermined refractive index value and the heat treatment temperature.

### DETAILED DESCRIPTION OF THE INVENTION

The present invention permits the manufacturing of optical glass elements while controlling the refractive index with good precision, an extremely important property of an optical glass element, and preventing deterioration of surface precision. Further, the application of the heat treatment of the present invention permits molding at an extremely short molding cycle time with high production efficiency.

Normally, when manufacturing a new optical glass element, the composition of the glass material to be used in precision press molding is developed first. Next, a procedure is adopted whereby the pressing schedule of maximum manufacturing efficiency using the glass material is selected. In the course of determining the pressing schedule, when an extremely short cycle time (that is, a high cooling rate) is employed, the refractive index of the glass tends to decrease. Even in such cases, the manufacturing method of the present invention permits rapid production of optical elements affording the predetermined optical performance without the necessity of developing a new glass material composition to compensate decrease in the refractive index.

In the method of manufacturing optical glass elements of the present invention, (1) a heat-softened glass material is press molded in a pressing mold; (2) the molded glass article obtained is cooled along with the pressing mold to a temperature less than or equal to the glass transition temperature of the molded glass article; and (3) the molded glass article is removed from the pressing mold. The manufacturing method of the present invention is characterized in that the molded glass article that has been removed is heat treated (sometimes referred to as “heat treatment”) at a temperature ranging from greater than or equal to the strain point of the glass minus 150° C. (strain point—150° C.), and less than the strain point.

The present inventors discovered that the refractive index of molded glass articles cooled following press molding, particularly rapidly cooled molded glass articles, could be adjusted by conducting a heat treatment in which the molded glass article was maintained at a temperature greater than or equal to the glass strain temperature minus 150° C. and less than the strain point. The strain point refers to the temperature corresponding to a viscosity of 4×10¹⁴ dPa.s. Generally, it was thought that at temperatures below the strain point, the glass did not become a viscous fluid, never developing new strain no matter how fast it was cooled, and that strain could not be removed, no matter how long such a temperature was maintained (see the Glass Engineering Handbook). Accordingly, at temperatures below the strain point, changes in refractive index were essentially thought not to occur.

However, as is indicated in the embodiment further below, the fact that even heat treatment at a temperature below the strain point causes the refractive index to change, adjusting the refractive index of the molded glass article to within the predetermined refractive index range, was discovered by the present inventors. The present inventors further discovered that not only did the heat treatment adjust the refractive index, but it also prevented deterioration of surface precision.

Normally, an astigma and irregularities tend to occur in the annealing step following press molding. An astigma is curvature deviation from the rotational symmetry of the lens and irregularities are rotationally symmetric curvature deviation occurring in the lens. This is because in the interior of the glass, which has become capable of viscous flow due to annealing, stress is released and deformation is generated. That is, through deformation, the radius of curvature of at least one of the transferred surfaces of the optical element increases or decreases locally. When this occurs in symmetrical fashion with respect to the optical axis, it is thought to become an irregularity and, when in asymmetrical fashion, it is thought to become an astigma. The deterioration of surface precision through such an irregularity and astigma is particularly likely to occur in rapidly cooled optical elements. Accordingly, when the cooling rate is increased to shorten the molding cycle time and annealing is conducted following pressing, there is a problem in that necessary surface precision cannot be achieved.

However, in the heat treatment of the present invention, the change in curvature is only slight and there is no deterioration in optical performance due to irregularities and an astigma. When optical elements that have been rapidly cooled after press molding are heat treated at a temperature greater than or equal to the strain point, irregularity and astigma are generated and surface precision deteriorates substantially. However, when subjected to the heat treatment of the present invention, even a molded glass article that has been rapidly cooled will adopt a predetermined refractive index while maintaining surface precision.

The cooling of the molded glass product permitting the refractive index to be brought within a predetermined range by implementing the heat treatment of the present invention is conducted so that the refractive index of an optical glass element obtained without heat treatment, for example, exceeds the permissible range of the predetermined optical index of the optical glass element. In such cooling, for example, following press molding, rapid cooling is conducted from the molding temperature to, or below, the Tg temperature. “Rapid cooling” means an average cooling rate from the press molding temperature to the glass transition temperature of greater than or equal to 100° C./min. Preferably, this average cooling rate falls with a range of from 100 to 300° C./min. However, even outside this range, the heat treatment of the present invention is effective on molded glass articles that have been subjected to cooling so as to exceed the permissible range of the predetermined refractive index of the optical glass element. The heat treatment of the present invention is most effective on molded glass articles that have been cooled at an average cooling rate of at least 200° C./min.

The heat treatment of the present invention is conducted following cooling on molded glass articles at a temperature greater than or equal to the strain point of the glass minus 150° C. (strain point—150° C.) and less than the strain point. However, the heat treatment temperature is desirably greater than or equal to the glass strain point minus 100° C. (strain point—100° C.) and less than the strain point, and preferably greater than or equal to the strain point minus 80° C. (strain point—80° C.) and less than the strain point.

The heat treatment of the present invention is conducted so that the refractive index of the molded glass article is changed and an optical glass element of predetermined refractive index is obtained. Accordingly, the heat treatment temperature is suitably selected within the above-stated range so that the optical glass element obtained by heat treatment has the predetermined refractive index. More specifically, for example, for a molded glass article of a given glass composition, the relation between the heat treatment temperature and the change in refractive index over the above-stated heat treatment temperature range can be experimentally determined in advance, and the heat treatment temperature can be determined based on both this result and the refractive index of the optical glass element that is desired.

The heat treatment temperature of the present invention can be determined based on the amount of change in refractive index, that is, the adjustment range of the refractive index. For example, for a molded glass article that has been molded under conditions of rapid cooling in the cooling step, the temperature of the heat treatment of the present invention can be raised to greatly change the refractive index. Further, for a molded glass article with a narrow refractive index adjustment range, the temperature of the heat treatment of the present invention can be made relatively low to reduce the amount of change in the refractive index. Since the molded glass article that has been cooled at a rapid rate has a lower refractive index than the molded glass article with a narrow refractive index adjustment range at the start of the heat treatment of the present invention, it is necessary to raise the temperature more to bring the refractive index into the predetermined range.

The heat treatment of the present invention is conducted at a prescribed temperature arrived at in the manner set forth above and the molded glass article is maintained at a certain temperature. Maintaining the temperature, for example, within a range of ±10° C. of the setting temperature is desirable from the perspective of being able to precisely control the refractive index with good reproducibility. Preferably, the temperature is maintained within a range of ±5° C. of the setting temperature.

The heat treatment duration, the period during which the molded glass product is maintained at the heat treatment temperature, need only be adequate to bring the refractive index of the molded glass article to a desired level, and is suitably determined from that perspective. Normally, the duration is from 0.5 to 15 hours, but this range is not intended as a limitation. When the duration is too short, the molded glass article is not adequately uniformly heated. When too long, not only do the results reach saturation and does production become inefficient, but heat deterioration (surface denaturation due to chemical reaction with the atmosphere and volatization of glass components) are imparted to the glass surface. The duration of the heat treatment is desirably 0.5 to 10 hours, preferably 1 to 5 hours, more preferably 1 to 3 hours.

The manufacturing method of the present invention has as its object to provide optical elements requiring high precision management of optical constants, and is well suited to adjustment of the refractive index of optical glass elements within a range of, for example, less than or equal to 150×10⁻⁵.

The refractive index of the optical element that is changed by the heat treatment of the present invention can fall within a range of from 20×10⁻⁵ to 150×10⁻⁵, desirably from 40×10⁻⁵ to 100×10⁻⁵.

The heat treatment of the present invention can also be conducted on molded glass articles within the pressing mold, but from the perspective of enhancing production efficiency by raising the coefficient of utilization (cycle time) of the pressing mold, multiple molded glass articles that have been removed from the pressing mold are desirably heat treated in one lot. For example, the molded glass articles that are removed from the pressing mold are placed on a flat heat-resistant plate of metal, ceramic, or the like, and subjected to the above-described heat treatment.

Following heat treatment, cooling can be conducted at an average cooling rate of from 30 to 300° C./hour to at least 170° C. below the strain point. This is because at more than 170° C. below the strain point, the effect on the refractive index can be nearly ignored. At a cooling rate of 30° C./hour or more, production efficiency is good. At a cooling rate of 300° C./hour or less, multiple lenses can be uniformly cooled with good reproducibility, and the process is easy to manage. Cooling following the heat treatment is desirably conducted at an average rate of from 100 to 200° C./hour.

The manufacturing method of the present invention, as set forth above, comprises (1) press molding a heat-softened glass material in a pressing mold; (2) cooling both the molded glass article obtained and the pressing mold to a temperature less than or equal to the glass transition temperature of the molded glass article; and (3) removing the molded glass article from the pressing mold. The usual methods employed in the manufacturing of optical glass elements can be suitably employed in press molding, cooling, and removal of the press molded glass articles. However, as stated above, the manufacturing method of the present invention is particularly suited to methods employing relatively rapid cooling conditions for molded glass articles following press molding.

The composition of the glass material (glass preform) employed in the manufacturing method of the present invention is determined based on the optical constants required of the optical element to be obtained. That is, the glass composition can be determined so as to achieve a refractive index falling within a prescribed range based on the thermal history imparted to the glass by press molding and the subsequent cooling step. However, for a glass material having a glass composition determined in this manner, the refractive index sometimes drops when the cooling rate is increased to achieve a shorter cycle time.

In such cases, it is possible to readjust the composition of the glass material to obtain optical elements of predetermined refractive index. However, this is quite tedious and undesirable from the perspective of production efficiency.

For example, when the glass material is press molded and then cooled to, or below, the transition temperature at an average cooling rate of v1, when obtaining glass elements of a predetermined refractive index of nd1, cooling at an average cooling rate of v2 (v1<v2) sometimes reduces the refractive index. Even in such cases, based on the present invention, it is possible to achieve the predetermined refractive index through the heat treatment of the present invention without having to reformulate the glass composition.

In the method of the present invention, a heat-softened glass material is press molded in a pressing mold. Specifically, in the press molding of the glass material, the pressing mold is heated to a prescribed temperature and a heat-softened glass material is pressed in the pressing mold. In particular, the present invention can be effectively applied to a pressing process in which a glass material that has been heated to within a prescribed temperature range is supplied to a pressing mold that has been heated to within a prescribed temperature range, and press molding is conducted. Preferably, the glass material is supplied to the pressing mold at a greater temperature than the temperature to which the pressing mold has been heated, and immediately press molded.

For example, the pressing mold is heated to a temperature equivalent to a glass material viscosity of 10⁷ to 10¹⁰ poises, while the glass material is first heated to a temperature equivalent to 10⁶ to 10⁸ poises that is greater than or equal to the temperature of the pressing mold, and then fed into the pressing mold. Immediately after feeding, the lower mold of the upper and lower molds is raised, or the upper mold is dropped, to conduct press molding.

Next, the molded glass article that has been obtained is cooled along with the pressing mold to a temperature less than or equal to the glass transition temperature of the molded glass article. This cooling begins with, or after, the start of pressing and is conducted to near Tg. That is, the cooling begins either simultaneously with the start of press molding, during press molding, or immediately following the conclusion of press molding.

The cooling is conducted from the molding temperature until the molded glass article and pressing mold reach Tg, with rapid cooling at an average rate of from 100 to 300° C./min being desirable, and 200 to 250° C./min being preferred. Here, when the temperatures of the pressing mold and glass material differ at the start of molding, for example, the temperature of the pressing mold can be calculated as the above molding temperature. Suitable rapid cooling methods include spraying an inert gas onto the outer surface of the pressing mold and running an inert gas through the interior of the pressing mold.

When such a method is employed in continuous press molding, it is possible to substantially shorten the amount of time the glass spends in the mold, thereby shortening the molding cycle time; this is desirable in that it results in extremely high production efficiency.

Following cooling, the molded glass article is removed (separated) from the pressing mold to obtain an optical glass element. However, in the present invention, the above-described heat treatment is applied to the molded glass article following cooling. Further, following press molding and cooling, the molded glass article can be subjected to the heat treatment of the present invention in one lot.

The present invention can be applied to the pressing method in which both the glass material and the pressing mold are heated while the glass material positions within the pressing mold and press molding is conducted when a prescribed temperature is reached. For example, a pressing mold is comprised of an upper mold, a lower mold, and a sleeve mold. The glass material is fed into the pressing mold prior to assembly. Once the upper mold, lower mold, and sleeve mold have been assembled, both the glass material and pressing mold are heated to a temperature suited to press molding. At that time, the mold and glass material are at approximately the same temperature. This temperature can be one that corresponds to a glass material viscosity of 10^{7.5} to 10⁹ poises. Cooling begins simultaneously with the start of press molding, during press molding, or following press molding. When the glass temperature reaches close to Tg, the molded glass article is separated from the mold and subjected to the above-described heat treatment.

There are no limitations on the type of glass element that can be obtained by the present invention. For example, the present invention can be applied to lenses, prisms, mirrors, gratings, microlenses, and stacked diffraction gratings. In particular, the present invention is particularly effective for optical lenses having at least one aspherical surface.

A marked effect is achieved with concave meniscus lenses, biconcave lenses, and convex meniscus lenses, which tend to undergo deformation during annealing. An effect is also achieved in biconvex lenses having large differences in thickness between center and perimeter.

The present invention is also effective in optical glasses undergoing large changes in viscosity with temperature change, that is, optical glasses in which high residual stress tends to develop. For example, use of the present invention is effective in borate glasses, phosphate glasses, and fluorophosphate glasses.

The application of the optical element is not specifically limited. However, it may be employed as the image pickup system lens of a camera (including video cameras, digital cameras, and mobile terminal built-in cameras), an optical pickup lens, or the like. Specifically, it is effectively employed in the image pickup systems of cameras employing optical lenses of high refractive index and high dispersion, or high refractive index and low dispersion.

Strain in the optical glass element obtained by the manufacturing method of the present invention can be rendered birefringent and less than or equal to 15 nm, which does not impair the above-stated applications. The manufacturing method of the present invention is also highly advantageous in that essentially no irregularity or astigma are generated in the optical glass element.

### Embodiments

The present invention is described in greater detail below through embodiments.

### Embodiment 1

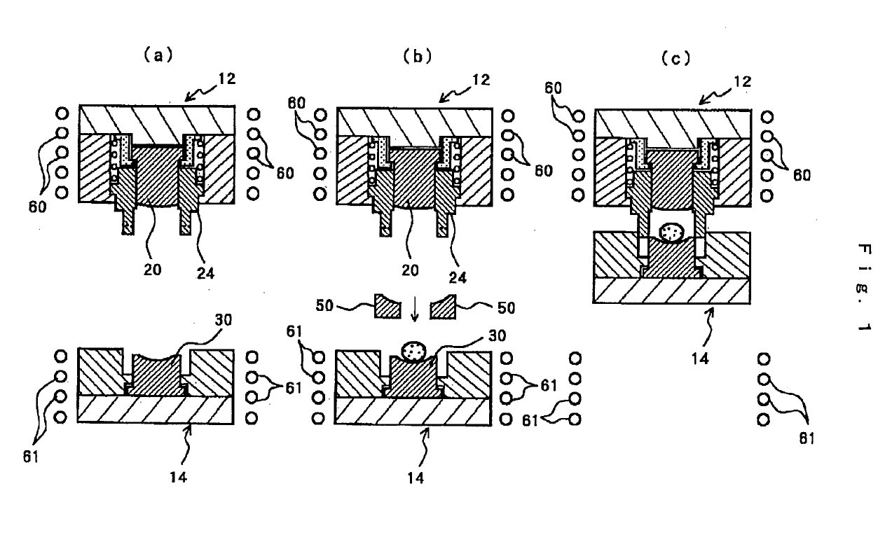

A convex meniscus lens 7.0 mm in pressing diameter and 1.25 mm in center thickness was molded with the pressing mold shown in FIG. 1 using a glass material in the form of borosilicate optical glass (Ts: 545° C., Tg: 515° C., strain point: 478° C.). The pressing mold employed had upper and lower molds with SiC molding surfaces produced by CVD that had both been polished to mirror surfaces, with a DLC film deposited by sputtering as a mold separation film. The upper and lower molds were encased in a base mold of tungsten alloy readily heated by induction. The upper and lower molds were heated by conduction of heat from the base mold as it was heated by a high-frequency induction heating element wound around the exterior. The temperature of the upper and lower molds was controlled by thermocouples, not shown, inserted into the upper and lower molds.

In FIG. 1, at least one from among upper mold 20 and lower mold 30 can be displaced. Lower mold 30 can be displaced together with the lower portion 14 of the pressing mold, which is raised by a vertical drive device (not shown). As shown in FIG. 1(a), upper mold 20 of the upper portion 12 of the pressing mold is preheated by a high-frequency heating coil 60. Lower mold 30 of the lower portion 14 of the pressing mold is preheated by a high-frequency heating coil 61 when lower portion 14 of the pressing mold is in a lowered position. Then, as shown in FIG. 1(b), a jig 50 that is holding the glass material carries the glass material, which has been heated to a prescribed temperature, to a position over lower mold 30 and drops the glass material onto the molding surface of lower mold 30. Once the preheated glass material has been delivered onto lower mold 30, jig 50 moves off. As shown in FIG. 1(c), lower mold 30 moves upward together with lower portion 14 of the pressing mold, engaging with upper portion 12 of the pressing mold, and press molding is conducted.

Inert gas (a nitrogen atmosphere) was employed as the device atmosphere. Heating was conducted until the temperature of the upper and lower molds (mold temperature) reached 610° C. (corresponding to a glass viscosity of 10^{7.3} dPa.s). Outside the mold, the glass material was maintained at a temperature of 635° C. (corresponding to a glass viscosity of 10^{6.5} dPa.s) while being floated on gas on the jig. The heat-softened glass material was fed by being dropped onto the lower mold while being maintained in a floating state. The lower mold was instantaneously raised and the glass material was press molded to prescribed thickness at a pressure of 100 km/cm². Next, nitrogen gas was blown onto the pressing mold to begin cooling. Twenty-five seconds later, when the temperature of the upper and lower molds had reached 505° C., which was equal to or lower than the glass transition temperature, the molded glass product was removed from the pressing mold and allowed to cool on the conveyor jig. The cooling rate from when press molded to prescribed thickness through to Tg averaged 250° C./min or more.

Heat Treatment

The molded product that had been molded and cooled as set forth above was reheated, maintained at a temperature of 400° C. for 120 min, cooled at a rate of 100° C./hour to 300° C., and then cooled to room temperature at a rate of 10° C./min.

Performance of the Molded Glass Product

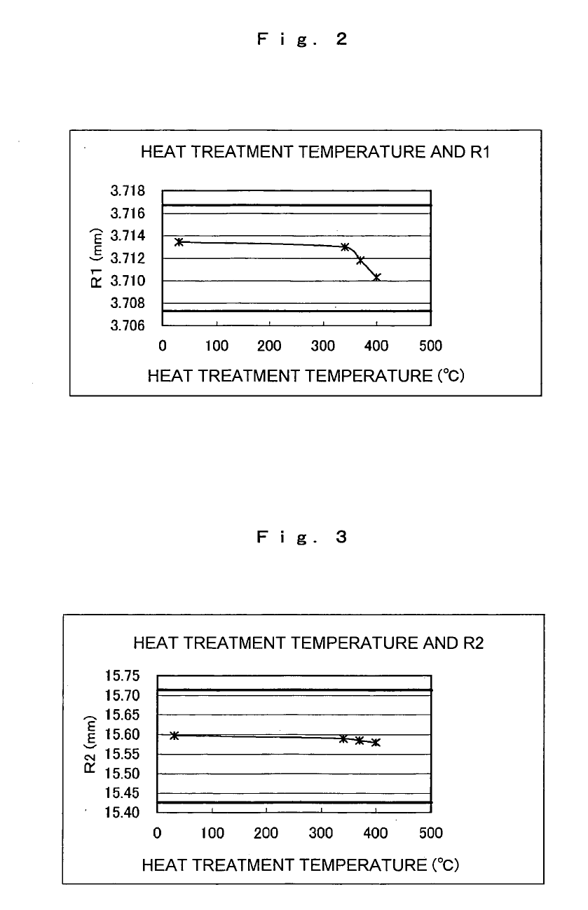

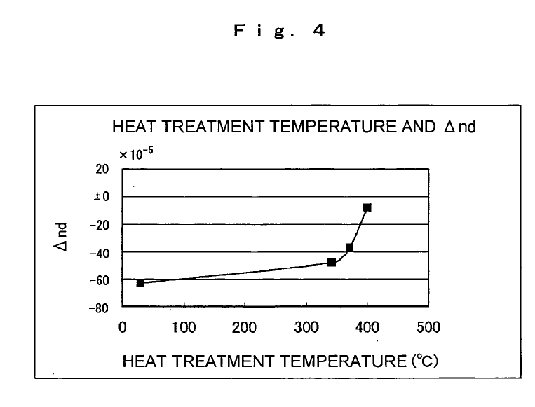

FIGS. 2 to 4 give the results of evaluation of the refractive index and curvature of the optical glass element obtained as set forth above. The radius of curvature of the first surface is denoted as R1 and that of the second surface as R2. The curvature tolerance was 3.712±0.005 mm for the first surface and 15.690±0.15 mm for the second surface.

The refractive index was increased 60—10⁻⁵ by the heat treatment. The variation in refractive index of 1,000 lenses obtained by continuous pressing fell within ±20×10⁻⁵ of the median. Only slight change was observed in the radius of curvature of the first and second surfaces, falling well within the tolerances. Measurement of surface precision by interferometry revealed that the irregularities and astigma indicated by the interference fringes were one fringes or less.

Measurement of the optical elements following heat treatment revealed a strain of less than or equal to 10 nm, confirming adequate performance.

1. A method of manufacturing an optical glass element comprising:
press-molding a heat-softened glass material in a pressing mold, cooling a glass article obtained by said press-molding along with the pressing mold to a temperature less than or equal to the glass transition temperature of the glass article,
removing the glass article from the pressing mold, and
subjecting the glass article to a heat-treatment at a temperature within a range of less than the strain point temperature and equal to or greater than the strain point temperature minus 150° C.

2. The method according to claim 1, wherein the cooling is conducted so that the refractive index of the molded glass article deviate from the range of refractive index, which range being predetermined for the optical glass element.

3. The manufacturing method according to claim 1, wherein, during the cooling, the average cooling rate within a range of from 100 to 300° C./min is employed until reaching the glass transition temperature.

4. The manufacturing method according to claim 1, wherein the heat treatment is conducted so that the refractive index of the molded glass article shifts to an extent sufficient to fall within the predetermined refractive index range of the optical glass element.

5. The manufacturing method according to claim 1, wherein the temperature of the heat treatment is determined based on the refractive index of the molded glass article and the predetermined refractive index of the optical glass element.

6. The manufacturing method according to claim 1, wherein the press molding comprises:
supplying the glass material to the pressing mold, said glass material being heated up to a temperature higher than the temperature of the pressing mold and being of glass viscosity of from 10⁶ to 10⁸ poises, said pressing mold being heated to a temperature corresponding to a viscosity of the glass material of from 10⁷ to 10¹⁰ poises, and
press molding the glass material immediately after the supplying.
